(19) United States
(12) Patent Application Publication
(10) Pub. No.: US 2024/0294753 A1
(43) Pub. Date: Sep. 5, 2024

(54) Mixture of Semi-Aromatic Polyamides and Molded Articles with Improved Weld Line Strength

(71) Applicant: BASF SE, Ludwigshafen am Rhein (DE)

(72) Inventors: Stefan SCHWIEGK, Ludwigshafen (DE); Gerhard LEITER, Ludwigshafen (DE); Susanne ZEIHER, Ludwigshafen (DE); Simone SCHILLO, Ludwigshafen (DE); Andre SCHAEFER, Ludwigshafen (DE); Thomas FUCHS, Ludwigshafen (DE); Nicolas TISSIER, Ludwigshafen (DE); Johann Martin SZEIFERT, Ludwigshafen (DE); Sabine FRIETSCH, Ludwigshafen (DE); Abdullah SHAIKH, Ludwigshafen (DE)

(21) Appl. No.: 17/754,770

(22) PCT Filed: Oct. 14, 2020
(86) PCT No.: PCT/EP2020/078863

§ 371 Date: Apr. 12, 2022

(30) Foreign Application Priority Data
Oct. 15, 2019 (EP) 19203279.5

(51) Int. Cl. C08L 77/06; C08K 7/14

(52) U.S. Cl. CPC C08L 77/06; C08K 7/14; C08L 2205/025

(57) ABSTRACT

Disclosed herein is a mixture of at least one semi-aromatic polyamide A) and at least one semi-aromatic polyamide B), both containing repeat units derived from terephthalic acid. Further disclosed herein are a polyamide molding composition including said mixture of polyamides, a molded article produced from said polyamide molding composition and a method of using the mixture of semi-aromatic polyamides for the production of a molded article with improved mechanical properties, in particular with improved weld line strength.

### BACKGROUND OF THE INVENTION

The present invention relates to a mixture of at least one semi-aromatic polyamide A) and at least one semi-aromatic polyamide B), both containing repeat units derived from terephthalic acid, a polyamide molding composition comprising said mixture of polyamides, a molded article produced from said polyamide molding composition and the use of the mixture of semi-aromatic polyamides for the production of a molded article with improved mechanical properties, in particular with improved weld line strength.

### STATE OF THE ART

Thermoplastic polyamide compositions have found widespread use in many application fields, e.g. automotive, electrical/electronic parts and furniture, because of their good physical properties and the ability to be conveniently and flexibly molded into a variety of articles. An important group of polyamides is that of semicrystalline or amorphous thermoplastic semiaromatic polyamides, which are especially notable for their high thermal stability and are also referred to as high performance polyamides (PPA, polyphthalamides). Polyamides for use in molding compositions for high-temperature applications must meet a wide range of requirements, generally combining good mechanical properties, even in the event of prolonged thermal stress, with good processibility.

To obtain a polymer article with certain desired material and mechanical properties the polyamide molding composition can be reinforced with a fibre material, e.g. to enhance the strength and elasticity of a polyamide molding. It is known, to use reinforced polyamide blends in the area of technical construction materials, since they exhibit good toughness and heat distortion temperature in addition to high rigidity.

US 2007/0117910 describes a fibre-reinforced polyamide blend comprising a polyamide matrix of a blend of A) polyamide 66 (an aliphatic homopolyamide) and B) polyamide 6T/66 (a semi-aromatic copolyamide) in certain weight ranges and as reinforcing material a mixture of glass fibres and carbon fibres. The reinforced polyamide molding material can be prepared from the polyamide blend, e.g. by compounding with cut fibres or continuous filaments on a twin-screw extruder.

Due to their production, injection molded parts usually comprise weld lines (seams). In these weld lines two melt strands of the polymer meet each other, and there is practically no reinforcement by fibres. In addition, the interaction in the polymer matrix is disturbed in this area. Therefore, weld lines are a point of mechanical weakness and usually also show reduced chemical resistance.

It is the object of the present invention to provide a polyamide molding composition that allows the production of molded articles, which do not have this weak point or only have it to a lesser extent.

It was now surprisingly found that this object is achieved if a small amount of a low-melting semi-aromatic polyamide is added to a major amount of a high-melting semi-aromatic polyamide, and the resulting polyamide mixture is used for the production of reinforced polyamide molding materials.

### SUMMARY OF THE INVENTION

In a first aspect, the invention provides a polyamide mixture comprising:
80 to 97% by weight of at least one polyamide A), containing repeat units derived from at least one aromatic dicarboxylic acid and at least one aliphatic diamine, wherein the at least one aromatic dicarboxylic acid comprises or consists of terephthalic acid, having a melting temperature Tₘ₁, and
3 to 20% by weight of at least one polyamide B), containing repeat units derived from at least one aromatic dicarboxylic acid and at least one aliphatic diamine, wherein the at least one aromatic dicarboxylic acid comprises or consists of terephthalic acid, having a melting temperature Tₘ₂,
   wherein Tₘ₁ is at least 10° C. higher than Tₘ₂.

In a second aspect, the invention provides a polyamide molding composition comprising
i) 25 to 100% by weight of at least one polyamide mixture as defined above and in the following,
ii) 0 to 75% by weight of at least one filler and reinforcing material,
iii) 0 to 50% by weight of at least one additive,
   where components i) to iii) together add up to 100% by weight.

In a third aspect, the invention provides a process for producing a polyamide molding composition, comprising melt-blending at least one polyamide A) and at least one polyamide B), as defined above and in the following, optionally at least one filler and reinforcing material and optionally at least one additive different from fillers and reinforcing materials.

In a fourth aspect, the invention provides a molded article produced from a polyamide molding composition according to the invention or prepared by the process according to the invention.

In a fifth aspect, the invention provides a process for producing a molded article by subjecting a polyamide molding composition according to the invention or prepared by the process according to the invention to an injection molding.

In a sixth aspect, the invention provides the use of a polyamide mixture as defined above and in the following or of a molding composition therefrom for production of a molded article with improved mechanical properties, in particular with improved weld line strength.

### DESCRIPTION OF THE INVENTION

### Polyamide Mixture

The polyamide mixture (polymer blend) according to the invention is based on a physical mixture of the at least one polyamide A) and the at least one polyamide B). The two components can be blended on a macroscopic scale or on a molecular scale. A simple embodiment of a polyamide mixture on a macroscopic scale is a physical mixture of polyamide granules or pellets comprising at least one polyamide A) and at least one polyamide B). For preparing a polyamide mixture on a molecular scale the at least one polyamide A) and the at least one polyamide B) can be compounded by known methods, by mixing or/and blending the polyamides and optionally filler and reinforcing materials and/or additives in a molten state. Suitable compounders are co-kneaders and twin screws (co- and counter rotating) as well internal mixers.

The blends of the at least one polyamide A) and the at least one polyamide B) are generally miscible. Therefore, it is possible to prepare polyamide mixtures according to the invention that are homogeneous according to DSC analysis. The corresponding polymer blends have a single-phase structure. In this case, only one glass transition temperature and only one melting point will be observed.

The melting temperatures (Tm) and glass transition temperatures (Tg) described in the context of this application can be determined by means of differential scanning calorimetry (DSC). The heating and cooling rates were each 20 K/min.

The melting temperature Tₘ₁ is the melting temperature of the pure component A). If component A) comprises more than one polyamide, but has a single melting temperature, then melting temperature Tₘ₁ is the single melting temperature of component A) (and not of one of its constituents). If component A) comprises more than one polyamide and has more than one melting temperature, then melting temperature Tₘ₁ is the lowest melting temperature of component A).

The melting temperature Tₘ₂ is the melting temperature of the pure component B). If component B) comprises more than one polyamide, but has a single melting temperature, then melting temperature Tₘ₂ is the single melting temperature of component B). If component B) comprises more than one polyamide and has more than one melting temperature, then melting temperature Tₘ₂ is the highest melting temperature of component B).

According to the invention, Tₘ₁ is at least 10° C. higher than Tₘ₂. If component A) and/or component B) has more than one melting temperature, then the difference between the lowest melting temperature of component A) and the highest melting temperature of component B) is at least 10° C.

Preferably, Tₘ₁ is at least 15° C. higher than Tₘ₂.

Preferably, the at least one polyamide A) has a melting temperature Tₘ₁ in the range from 290 to 340° C., more preferably 290 to 330° C.

Preferably, the at least one polyamide B) has a melting temperature Tₘ₂ in the range from 250 to 315° C., more preferably 260 to 280° C.

The polyamide mixture according to the invention comprises polyamides A) and B), containing repeat units derived from terephthalic acid (i.e. an aromatic dicarboxylic acid) and at least one aliphatic diamine. They may optionally contain repeat units derived from further comonomers as defined in the following.

The at least one polyamide A) and the at least one polyamide B) are semi-aromatic polyamides. The term “semi-aromatic” denotes polyamides containing repeat units derived from at least one aromatic monomer (usually at least one aromatic dicarboxylic acid) and repeat units derived from at least one aliphatic monomer (usually at least one aliphatic diamine). In contrast, the term “fully aliphatic” polyamide denotes polyamides containing repeat units derived from at least one aliphatic carboxylic acid monomer and at least one aliphatic diamine monomer.

The condensation of the monomers of the acid component and of the diamine component, and also of any optional monomer used, forms repeat units or end groups in the form of amides derived from the respective monomers. These monomers generally account for at least 90° mol %, preferably at least 95 mol %, especially at least 99 mol %, of all the repeat units and end groups present in the polyamides A) and B). In addition, the polyamides A) and B) may also comprise small amounts of other repeat units which may result e.g. from degradation reactions or side reactions of the monomers, for example of the diamines.

The polyamides are designated in the context of the invention using abbreviations, some of which are customary in the art, which consist of the letters PA followed by numbers and letters. Some of these abbreviations are standardized in DIN EN ISO 1043-1. Polyamides which can be derived from aminocarboxylic acids of the H₂N—(CH₂)ₓ—COOH type or the corresponding lactams are identified as PA Z, where Z denotes the number of carbon atoms in the monomer. For example, PA 6 represents the polymer of ε-caprolactam or of ω-aminocaproic acid. Polyamides derivable from diamines and dicarboxylic acids of the H₂N—(CH₂)ₓ—NH₂ and HOOC—(CH₂)_{y}—COOH types are identified as PA Z1Z2, where Z1 denotes the number of carbon atoms in the diamine and Z2 the number of carbon atoms in the dicarboxylic acid. Copolyamides are designated by listing the components in the sequence of their proportions, separated by slashes. For example, PA 66/610 is the copolyamide of hexamethylenediamine, adipic acid and sebacic acid. For some of the monomers which are used in accordance with the invention, the following letter abbreviations are used: T=terephthalic acid, I=isophthalic acid, D=2-methylpentamethylene diamine, MXDA=m-xylylenediamine, IPDA=isophoronediamine, PACM=4,4′-methylenebis-(cyclohexylamine), MACM=2,2′-dimethyl-4,4′-methylenebis(cyclohexylamine).

Hereinafter, the expression “C₁-C₄-alkyl” comprises unsubstituted straight-chain and branched C₁-C₄-alkyl groups. Examples of C₁-C₄-alkyl groups are especially methyl, ethyl, propyl, isopropyl, n-butyl, isobutyl, sec-butyl, tert-butyl (1,1-dimethylethyl).

In the aromatic dicarboxylic acids, aliphatic dicarboxylic acids, cycloaliphatic dicarboxylic acids and monocarboxylic acids mentioned hereinafter, the carboxyl groups may each be present in underivatized form or in the form of derivatives. In the case of dicarboxylic acids, not one of the carboxyl groups, one carboxyl group or both carboxyl groups may be in the form of a derivative. Suitable derivatives are anhydrides, esters, acid chlorides, nitriles and isocyanates. Preferred derivatives are anhydrides or esters. Anhydrides of dicarboxylic acids may be in monomeric or in polymeric form. Preferred esters are alkyl esters and vinyl esters, more preferably C₁-C₄-alkyl esters, especially the methyl esters or ethyl esters.

The components for formation of polyamides A) and B) are preferably selected from
a) terephthalic acid and derivatives of terephthalic acid,
b) aliphatic diamines,
c) optionally aromatic dicarboxylic acids and derivatives of aromatic dicarboxylic acids different from a)
d) optionally cycloaliphatic diamines,
e) optionally aromatic diamines,
f) optionally aliphatic or cycloaliphatic dicarboxylic acids,
g) optionally monocarboxylic acids,
h) optionally monoamines,
i) optionally tri- or higher functional amines,
j) optionally lactams,
k) optionally ω-amino acids,
l) optionally compounds which are different than a) to k) and are cocondensable therewith.

Component a) is selected from terephthalic acid and derivatives thereof.

The aliphatic diamine b) is preferably selected from tetramethylene diamine, pentamethylene diamine, hexamethylene diamine, heptamethylene diamine, octamethylene diamine, nonamethylene diamine, decamethylene diamine, undecamethylene diamine, dodecamethylene diamine, 2-ethyltetramethylene diamine, 2-methylpentamethylene diamine, 2,2,4-trimethylhexamethylenediamine, 2,4,4-trimethylhexamethylenediamine, 2-methyloctamethylene diamine, 2,4-dimethyloctamethylenediamine, 5-methylnonamethylene diamine and mixtures thereof.

In a preferred embodiment, the aliphatic diamine used for the preparation of polyamide A) is exclusively selected from hexamethylene diamine, 2-methylpentamethylene diamine, tetramethylene diamine and mixtures thereof.

In a preferred embodiment, the aliphatic diamine used for the preparation of polyamide B) is exclusively hexamethylene diamine.

The aromatic dicarboxylic acids c) are preferably selected from phthalic acid, isophthalic acid, naphthalenedicarboxylic acids, 2-chloroterephthalic acid, 2-methylterephthalic acid, 5-methylisophthalic acid, 5-sulfoisophthalic and the derivatives and mixtures of the aforementioned aromatic dicarboxylic acids. Particularly preferred is isophthalic acid.

In a preferred embodiment, the at least one polyamide A) contains repeat units derived from terephthalic acid or a mixture of terephthalic acid and isophthalic acid as the at least one aromatic dicarboxylic acid.

In a preferred embodiment, the at least one polyamide B) contains repeat units derived from terephthalic acid as the at least one aromatic dicarboxylic acid. In this embodiment, the at least one polyamide B) does not contain any repeat units derived from an aromatic dicarboxylic acid different from terephthalic acid.

Preferably, the at least one polyamide A) has a proportion of aromatic dicarboxylic acids among all the dicarboxylic acids of at least 50 mol %, more preferably of 70 mol % to 100 mol %, in particular 100 mol %. In a specific embodiment, the at least one polyamide A) has a proportion of terephthalic acid or a mixture of terephthalic acid and isophthalic acid, based on all the dicarboxylic acids, of at least 50 mol %, preferably of 70 mol % to 100 mol %, in particular 100 mol %.

In a first preferred embodiment, the at least one polyamide B) has a proportion of aromatic dicarboxylic acids among all the dicarboxylic acids of at least 50 mol %, more preferably of 70 mol % to 100 mol %, in particular 100 mol %. In a specific embodiment, the at least one polyamide B) has a proportion of terephthalic acid, based on all the dicarboxylic acids, of at least 50 mol %, preferably of 70 mol % to 100 mol %, in particular 100 mol %.

In a second preferred embodiment, the at least one polyamide B) has a proportion of aromatic dicarboxylic acids among all the dicarboxylic acids of 10 to 90 mol % and of aliphatic dicarboxylic acids among all the dicarboxylic acids of 10 to 90 mol %. In a specific embodiment, the at least one polyamide B) has a proportion of terephthalic acid among all the dicarboxylic acids of 50 to 90 mol % and of adipic acid among all the dicarboxylic acids of 10 to 50 mol %.

The cycloaliphatic diamines d) are preferably selected from bis(4-aminocyclohexyl)-methane, 3,3′-dimethyl-4,4′-diaminodicyclohexylmethane and mixtures thereof. In a specific embodiment, the at least one polyamide A) does not contain any repeat units derived from cycloaliphatic diamines d). In a further specific embodiment, the at least one polyamide B) does not contain any repeat units derived from cycloaliphatic diamines d).

Suitable aromatic diamines e) are selected from bis(4-aminophenyl)methane, 3-methylbenzidine, 2,2-bis(4-aminophenyl)propane, 1,1-bis(4-aminophenyl)cyclo-hexane, 1,2-diaminobenzene, 1,4-diaminobenzene, 1,4-diaminonaphthalene, 1,5-diaminonaphthalene, 1,3-diaminotoluene(s), m-xylylenediamine, N,N′-dimethyl-4,4′-biphenyldiamine, bis(4-methylaminophenyl)methane, 2,2-bis(4-methylaminophenyl)-propane or mixtures thereof. In a specific embodiment, the at least one polyamide A) does not contain any repeat units derived from aromatic diamines e). In a further specific embodiment, the at least one polyamide B) does not contain any repeat units derived from aromatic diamines e).

The aliphatic or cycloaliphatic dicarboxylic acids f) are preferably selected from oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, maleic acid, fumaric acid or itaconic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid and mixtures thereof. In a specific embodiment, the at least one polyamide A) does not contain any repeat units derived from aliphatic or cycloaliphatic dicarboxylic acids f). In a further specific embodiment, the at least one polyamide B) does not contain any repeat units derived from aliphatic or cycloaliphatic dicarboxylic acids f).

Optionally, the polyamides A) and/or B) may comprise at least one copolymerized monocarboxylic acid g). The monocarboxylic acids g) serve to end-cap the polyamides prepared in accordance with the invention. Suitable monocarboxylic acids are in principle all of those capable of reacting with at least some of the amino groups available under the reaction conditions of the polyamide condensation. Suitable monocarboxylic acids g) are aliphatic monocarboxylic acids, alicyclic monocarboxylic acids and aromatic monocarboxylic acids. These include acetic acid, propionic acid, n-, iso- or tert-butyric acid, valeric acid, trimethylacetic acid, caproic acid, enanthic acid, caprylic acid, pelargonic acid, capric acid, undecanoic acid, lauric acid, tridecanoic acid, myristic acid, palmitic acid, stearic acid, pivalic acid, cyclohexanecarboxylic acid, benzoic acid, methylbenzoic acids, α-naphthalenecarboxylic acid, β-naphthalene-carboxylic acid, phenylacetic acid, oleic acid, ricinoleic acid, linoleic acid, linolenic acid, erucic acid, fatty acids from soya, linseeds, castor oil plants and sunflowers, acrylic acid, methacrylic acid, Versatic® acids, Koch® acids and mixtures thereof. In a specific embodiment, the at least one polyamide A) does not contain any repeat units derived from monocarboxylic acids g). In a further specific embodiment, the at least one polyamide B) does not contain any repeat units derived from monocarboxylic acids g).

The aliphatic and the semiaromatic polyamides may comprise at least one copolymerized monoamine h). The monoamines h) serve to end-cap the polyamides prepared in accordance with the invention. Suitable monoamines are in principle all of those capable of reacting with at least some of the carboxylic acid groups available under the reaction conditions of the polyamide condensation. In a specific embodiment, the at least one polyamide A) does not contain any repeat units derived from monoamines h). In a further specific embodiment, the at least one polyamide B) does not contain any repeat units derived from monoamines h).

For preparation of the aliphatic and the semiaromatic polyamides, it is additionally possible to use at least one at least trifunctional amine i). These include N′-(6-amino-hexyl) hexane-1,6-diamine, N′-(12-aminododecyl)dodecane-1,12-diamine, N′-(6-amino-hexyl) dodecane-1,12-diamine, N′-[3-(aminomethyl)-3,5,5-trimethylcyclohexyl]hexane-1,6-diamine, N′-[3-(aminomethyl)-3,5,5-trimethylcyclohexyl]dodecane-1,12-diamine, N′-[(5-amino-1,3,3-trimethylcyclohexyl)methyl]hexane-1,6-diamine, N′-[(5-amino-1,3,3-trimethylcyclohexyl) methyl]dodecane-1,12-diamine, 3-[[[3-(aminomethyl)-3,5,5-trimethylcyclohexyl]amino]methyl]-3,5,5-trimethylcyclohexanamine, 3-[[(5-amino-1,3,3-trimethylcyclohexyl) methylamino]methyl]-3,5,5-trimethylcyclohexanamine, 3-(amino-methyl)-N-[3-(aminomethyl)-3,5,5-trimethylcyclohexyl]-3,5,5-trimethylcyclohexanamine. In a specific embodiment, the at least one polyamide A) does not contain any repeat units derived from at least trifunctional amines i). In a further specific embodiment, the at least one polyamide B) does not contain any repeat units derived from at least trifunctional amines i).

Suitable lactams j) are ε-caprolactam, 2-piperidone (δ-valerolactam), 2-pyrrolidone (γ-butyrolactam), capryllactam, enantholactam, lauryllactam and mixtures thereof. In a specific embodiment, the at least one polyamide A) and the at least one polyamide B) do not contain any repeat units derived from component j).

Suitable ω-amino acids k) are 6-aminocaproic acid, 7-aminoheptanoic acid, 11-aminoundecanoic acid, 12-aminododecanoic acid and mixtures thereof. In a specific embodiment, the at least one polyamide A) and the at least one polyamide B) do not contain any repeat units derived from component k).

Suitable compounds l) which are different from a) to k) and are cocondensable therewith are at least tribasic carboxylic acids, diaminocarboxylic acids, etc. Suitable compounds I) are additionally 4-[(Z)-N-(6-aminohexyl)-C-hydroxycarbonimidoyl]benzoic acid, 3-[(Z)-N-(6-aminohexyl)-C-hydroxycarbonimidoyl]benzoic acid, (6Z)-6-(6-amino-hexylimino)-6-hydroxyhexanecarboxylic acid, 4-[(Z)-N-[(5-amino-1,3,3-trimethylcyclo-hexyl)methyl]-C-hydroxycarbonimidoyl]benzoic acid, 3-[(Z)-N-[(5-amino-1,3,3-trimethyl-cyclohexyl) methyl]-C-hydroxycarbonimidoyl]benzoic acid, 4-[(Z)-N-[3-(aminomethyl)-3,5,5-trimethylcyclohexyl]-C-hydroxycarbonimidoyl]benzoic acid, 3-[(Z)-N-[3-(amino-methyl)-3,5,5-trimethylcyclohexyl]-C-hydroxycarbonimidoyl]benzoic acid and mixtures thereof. In a specific embodiment, the at least one polyamide A) and the at least one polyamide B) do not contain any repeat units derived from component I).

The at least one polyamide A) is preferably selected from PA 6T/6I, PA 6T/DT, PA 4T and mixtures thereof.

In a special embodiment, polyamide A) is a PA 6T/6I. Preferably, polyamide A) is a PA 6T/6I, wherein 50 to 95 mol % of the repeat units derived from at least one aromatic dicarboxylic acid are derived from terephthalic acid and 5 to 50 mol % of the repeat units derived from at least one aromatic dicarboxylic acid are derived from isophthalic acid. More preferably, polyamide A) is a PA 6T/6I, wherein 60 to 80 mol % of the repeat units derived from at least one aromatic dicarboxylic acid are derived from terephthalic acid, and 20 to 40 mol % of the repeat units derived from at least one aromatic dicarboxylic acid are derived from isophthalic acid.

In a further special embodiment, polyamide A) is a PA 6T/DT (wherein D denotes 2-methylpentamethylene diamine). Preferably, polyamide A is PA 6T/DT, wherein 60 to 80 mol % of the repeat units derived from at least one aliphatic diamine are derived from hexamethylene diamine, and 20 to 40 mol % of the repeat units derived from at least one aliphatic diamine are derived from 2-methylpentamethylene diamine.

In a further special embodiment, polyamide A) is a PA 4T.

The at least one polyamide B) is preferably selected from PA 8T, PA 9T, PA 10T, PA 6T/66 and mixtures thereof. More preferably, the at least one polyamide B) is PA 9T or PA 6T/66. In the sense of the invention, PA 9T also encompasses polyamides, wherein the amine repeat units comprise a mixture of nonamethylene diamine and 2-methyloctamethylene diamine. The amount of 2-methyloctamethylene diamine can be varied to set the melting temperature of the PA 9T to the desired value.

According to the invention, the polyamide mixture comprises:
80 to 97% by weight of at least one polyamide A), and
3 to 20% by weight of at least one polyamide B).

Preferably, the polyamide mixture comprises:
88 to 96% by weight of at least one polyamide A), and
4 to 12% by weight of at least one polyamide B).

With regard to suitable and preferred embodiments of the polyamides A) and B) reference is made to the above-mentioned description.

Preferably, the polyamide mixture consists of:
80 to 97% by weight of at least one polyamide A), and
3 to 20% by weight of at least one polyamide B),
   wherein the amounts of A) and B) add up to 100% by weight.

More preferably, the polyamide mixture consists of:
88 to 96% by weight of at least one polyamide A), and
4 to 12% by weight of at least one polyamide B),
   wherein the amounts of A) and B) add up to 100% by weight.

In a preferred embodiment, the polyamide mixture comprises:
A) 80 to 97% by weight PA 6T/6I, and
B) 3 to 20% by weight PA 6T66 and/or PA 9T.

Especially, the polyamide mixture consists of:
A) 80 to 97% by weight PA 6T/6I, and
B) 3 to 20% by weight PA 6T66 and/or PA 9T,
   wherein the amounts of A) and B) add up to 100% by weight.

In a further preferred embodiment, the polyamide mixture comprises:
A) 80 to 97% by weight PA 6T/DT, and
B) 3 to 20% by weight PA 6T66 and/or PA 9T.

Especially, the polyamide mixture consists of:
A) 80 to 97% by weight PA 6T/DT, and
B) 3 to 20% by weight PA 6T66 and/or PA 9T,
   wherein the amounts of A) and B) add up to 100% by weight.

In a further preferred embodiment, the polyamide mixture comprises:
A) 80 to 97% by weight PA 4T, and
B) 3 to 20% by weight PA 6T66 and/or PA 9T.

Especially, the polyamide mixture consists of:
A) 80 to 97% by weight PA 4T, and
B) 3 to 20% by weight PA 6T66 and/or PA 9T,
   wherein the amounts of A) and B) add up to 100% by weight.

### Polyamide Molding Composition

A further object of the invention is a polyamide molding composition comprising
i) 25 to 100% by weight of at least one polyamide mixture as defined above,
ii) 0 to 75% by weight of at least one filler and reinforcing material,
iii) 0 to 50% by weight of at least one additive,
   where components i) to iii) together add up to 100% by weight.

The term “filler and reinforcing material” (=component ii) is understood in a broad sense in the context of the invention and comprises particulate fillers, fibrous substances and any intermediate forms. Particulate fillers may have a wide range of particle sizes ranging from particles in the form of dust to large grains. Useful filler materials include organic or inorganic fillers and reinforcers. For example, it is possible to use inorganic fillers, such as kaolin, chalk, wollastonite, talc, calcium carbonate, silicates, titanium dioxide, zinc oxide, graphite, glass particles, e.g. glass beads, nanoscale fillers, such as carbon nanotubes, carbon black, nanoscale sheet silicates, nanoscale alumina (Al₂O₃), nanoscale titania (TiO₂), graphene, permanently magnetic or magnetizable metal compounds and/or alloys, sheet silicates and nanoscale silica (SiO₂). The fillers may also have been surface treated.

Examples of sheet silicates usable in the inventive molding compositions include kaolins, serpentines, talc, mica, vermiculites, illites, smectites, montmorillonite, hectorite, double hydroxides or mixtures thereof. The sheet silicates may have been surface treated or may be untreated.

In addition, it is possible to use one or more fibrous substances. These are preferably selected from known inorganic reinforcing fibers, such as boron fibers, glass fibers, carbon fibers, silica fibers, ceramic fibers and basalt fibers; organic reinforcing fibers, such as aramid fibers, polyester fibers, nylon fibers, polyethylene fibers and natural fibers, such as wood fibers, flax fibers, hemp fibers and sisal fibers.

It is especially preferable to use glass fibers, carbon fibers, aramid fibers, boron fibers, metal fibers or potassium titanate fibers.

Specifically, chopped glass fibers are used. More particularly, component ii) comprises glass fibers and/or carbon fibers, preference being given to using short fibers. These preferably have a length in the range from 2 to 50 mm and a diameter of 5 to 40 μm. A typical diameter is about 10 μm. In the alternative, it is possible to use continuous fibers (rovings). Suitable fibers are those having a circular and/or noncircular cross-sectional area, in which latter case the ratio of dimensions of the main cross-sectional axis to the secondary cross-sectional axis is especially >2, preferably in the range from 2 to 8 and more preferably in the range from 3 to 5.

In a specific execution, component ii) comprises what are called “flat glass fibers”. These specifically have a cross-sectional area which is oval or elliptical or elliptical and provided with indentation(s) (called “cocoon” fibers), or rectangular or virtually rectangular. Preference is given here to using glass fibers with a noncircular cross-sectional area and a ratio of dimensions of the main cross-sectional axis to the secondary cross-sectional axis of more than 2, preferably of 2 to 8, especially of 3 to 5.

For reinforcement of the inventive molding compositions, it is also possible to use mixtures of glass fibers having circular and noncircular cross sections. In a specific execution, the proportion of flat glass fibers, as defined above, predominates, meaning that they account for more than 50% by weight of the total mass of the fibers.

If rovings of glass fibers are used as component ii), these preferably have a diameter of 10 to 20 μm, preferably of 12 to 18 μm. In this case, the cross section of the glass fibers may be round, oval, elliptical, virtually rectangular or rectangular. Particular preference is given to what are called flat glass fibers having a ratio of the cross-sectional axes of 2 to 5. More particularly, E glass fibers are used. However, it is also possible to use all other glass fiber types, for example A, C, D, M, S or R glass fibers or any desired mixtures thereof, or mixtures with E glass fibers. The polyamide molding compositions according to the invention can be produced by the known processes for producing long fiber-reinforced rod pellets, especially by pultrusion processes, in which the continuous fiber strand (roving) is fully saturated with the polymer melt and then cooled and cut. The long fiber-reinforced rod pellets obtained in this manner, which preferably have a pellet length of 3 to 25 mm, especially of 4 to 12 mm, can be processed further by the customary processing methods, for example injection molding or press molding, to give moldings.

The polyamide molding composition according to the invention comprises preferably 15 to 65% by weight, more preferably 30 to 60% by weight, of at least one filler and reinforcing material ii), based on the total weight of the polyamide molding composition.

Suitable additives iii) are heat stabilizers, flame retardants, light stabilizers (UV stabilizers, UV absorbers or UV blockers), lubricants, dyes, nucleating agents, metallic pigments, metal flakes, metal-coated particles, antistats, conductivity additives, demolding agents, optical brighteners, defoamers, etc.

As component iii), the molding compositions according to the invention comprise preferably 0.01 to 3% by weight, more preferably 0.02 to 2% by weight and especially 0.1 to 1.5% by weight of at least one heat stabilizer.

The heat stabilizers are preferably selected from copper compounds, secondary aromatic amines, sterically hindered phenols, phosphites, phosphonites and mixtures thereof.

If a copper compound is used, the amount of copper is preferably 0.003 to 0.5%, especially 0.005 to 0.3% and more preferably 0.01 to 0.2% by weight, based on the sum of components i) to iii).

If stabilizers based on secondary aromatic amines are used, the amount of these stabilizers is preferably 0.2 to 2% by weight, more preferably from 0.2 to 1.5% by weight, based on the sum of components i) to iii).

If stabilizers based on sterically hindered phenols are used, the amount of these stabilizers is preferably 0.1 to 1.5% by weight, more preferably from 0.2 to 1% by weight, based on the sum of components i) to iii).

If stabilizers based on phosphites and/or phosphonites are used, the amount of these stabilizers is preferably 0.1 to 1.5% by weight, more preferably from 0.2 to 1% by weight, based on the sum of components i) to iii).

Suitable compounds iii) of mono- or divalent copper are, for example, salts of mono- or divalent copper with inorganic or organic acids or mono- or dihydric phenols, the oxides of mono- or divalent copper or the complexes of copper salts with ammonia, amines, amides, lactams, cyanides or phosphines, preferably Cu(I) or Cu(II) salts of the hydrohalic acids or of the hydrocyanic acids or the copper salts of the aliphatic carboxylic acids. Particular preference is given to the monovalent copper compounds CuCl, CuBr, Cul, CuCN and Cu₂O, and to the divalent copper compounds CuCl₂, CuSO₄, CuO, copper(II) acetate or copper(II) stearate.

The copper compounds are commercially available, or the preparation thereof is known to those skilled in the art. The copper compound can be used as such or in the form of concentrates. A concentrate is understood to mean a polymer, preferably of the same chemical nature as component iii), which comprises the copper salt in high concentration. The use of concentrates is a standard method and is employed particularly frequently when very small amounts of a feedstock have to be metered in. Advantageously, the copper compounds are used in combination with further metal halides, especially alkali metal halides, such as Nal, Kl, NaBr, KBr, in which case the molar ratio of metal halide to copper halide is 0.5 to 20, preferably 1 to 15 and more preferably 3 to 10.

Particularly preferred examples of stabilizers which are based on secondary aromatic amines and are usable in accordance with the invention are adducts of phenylenediamine with acetone (Naugard A), adducts of phenylenediamine with linolene, 4,4′-Bis(alpha, alpha-dimethylbenzyl)diphenylamine (Naugard® 445), N,N′-dinaphthyl-p-phenylenediamine, N-phenyl-N′-cyclohexyl-p-phenylenediamine or mixtures of two or more thereof.

Preferred examples of stabilizers which are based on sterically hindered phenols and are usable in accordance with the invention are N,N′-hexamethylenebis-3-(3,5-di-tert-butyl-4-hydroxyphenyl)propionamide, bis(3,3-bis(4′-hydroxy-3′-tert-butylphenyl)butanoic acid) glycol ester, 2,1′-thioethyl bis(3-(3,5-di-tert-butyl-4-hydroxyphenyl)propionate, 4,4′-butylidenebis(3-methyl-6-tert-butylphenol), triethylene glycol 3-(3-tert-butyl-4-hydroxy-5-methylphenyl) propionate or mixtures of two or more of these stabilizers.

Preferred phosphites and phosphonites are triphenyl phosphite, diphenyl alkyl phosphite, phenyl dialkyl phosphite, tris(nonylphenyl) phosphite, trilauryl phosphite, trioctadecyl phosphite, distearyl pentaerythrityl diphosphite, tris(2,4-di-tert-butylphenyl) phosphite, diisodecyl pentaerythrityl diphosphite, bis(2,4-di-tert-butylphenyl) pentaerythrityl diphosphite, bis(2,6-di-tert-butyl-4-methylphenyl) pentaerythrityl diphosphite, diisodecyloxy pentaerythrityl diphosphite, bis(2,4-di-tert-butyl-6-methyl-phenyl) pentaerythrityl diphosphite, bis(2,4,6-tris(tert-butylphenyl)) pentaerythrityl diphosphite, tristearylsorbitol triphosphite, tetrakis(2,4-di-tert-butylphenyl)-4,4′-biphe-nylene diphosphonite, 6-isooctyloxy-2,4,8, 10-tetra-tert-butyl-12H-dibenzo-[d,g]-1,3,2-dioxaphosphocin, 6-fluoro-2,4,8,10-tetra-tert-butyl-12-methyldibenzo-[d,g]-1,3,2-dioxaphosphocin, bis(2,4-di-tert-butyl-6-methylphenyl)methyl phosphite and bis(2,4-di-tert-butyl-6-methylphenyl) ethyl phosphite. More particularly, preference is given to tris[2-tert-butyl-4-thio(2′-methyl-4′-hydroxy-5′-tert-butyl)phenyl-5-methyl]phenyl phosphite and tris(2,4-di-tert-butylphenyl)phosphite (Hostanox® PAR24: commercial product from BASF SE).

A preferred embodiment of the heat stabilizer consists in the combination of organic heat stabilizers (especially Hostanox PAR 24 and Irganox 1010), a bisphenol A-based epoxide (especially Epikote 1001) and copper stabilization based on Cul and Kl. An example of a commercially available stabilizer mixture consisting of organic stabilizers and epoxides is Irgatec NC66 from BASF SE. More particularly, preference is given to heat stabilization exclusively based on Cul and Kl. Aside from the addition of copper or copper compounds, the use of further transition metal compounds, especially metal salts or metal oxides of group VB, VIB, VIIB or VIIIB of the Periodic Table, is ruled out. In addition, it is preferable not to add any transition metals of group VB, VIB, VIIB or VIIIB of the Periodic Table, for example iron powder or steel powder, to the inventive molding composition.

The molding compositions according to the invention comprise preferably 0 to 30% by weight, more preferably 0 to 20% by weight, based on the total weight of components i) to iii), of at least one flame retardant as additive iii). When the inventive molding compositions comprise at least one flame retardant, they preferably do so in an amount of 0.01 to 30% by weight, more preferably of 0.1 to 20% by weight, based on the total weight of components i) to iii). Useful flame retardants iii) include halogenated and halogen-free flame retardants and synergists thereof (see also Gächter/Müller, 3rd edition 1989 Hanser Verlag, chapter 11). Preferred halogen-free flame retardants are red phosphorus, phosphinic or diphosphinic salts and/or nitrogen-containing flame retardants, such as melamine, melamine cyanurate, melamine sulfate, melamine borate, melamine oxalate, melamine phosphate (primary, secondary) or secondary melamine pyrophosphate, neopentyl glycol boric acid melamine, guanidine and derivatives thereof known to those skilled in the art and also polymeric melamine phosphate (CAS No.: 56386-64-2 or 218768-84-4, and also EP 1095030), ammonium polyphosphate, trishydroxyethyl isocyanurate (optionally also ammonium polyphosphate in a mixture with trishydroxyethyl isocyanurate) (EP 584567). Further N-containing or P-containing flame retardants, or PN condensates suitable as flame retardants, can be found in DE 10 2004 049 342. This document also discloses synergists customary for this purpose, such as oxides or borates. Suitable halogenated flame retardants are, for example, oligomeric brominated polycarbonates (BC 52 Great Lakes) or polypentabromobenzyl acrylates with N greater than 4 (FR 1025 Dead sea bromine), reaction products of tetrabromobisphenol A with epoxides, brominated oligomeric or polymeric styrenes, Dechlorane, which are usually used with antimony oxides as synergists (for details and further flame retardants see DE-A-10 2004 050 025).

The antistats used in the inventive molding compositions may, for example, be carbon black and/or carbon nanotubes. The use of carbon black may also serve to improve the black color of the molding composition. However, the molding composition may also be free of metallic pigments.

### Process for Producing a Polyamide Molding Composition

As mentioned before, the polyamide mixture according to the invention can be a polymer blend on a macroscopic scale, e.g. in the form of a mixture of polyamide pellets, comprising at least one polyamide A) and at least one polyamide B). In this embodiment, at least one composition comprising at least one polyamide A) and at least one composition comprising at least one polyamide B) can be mixed to give a dry blend which is subsequently further processed. Said further processing can be carried out together with or immediately after the production of the polyamide mixture or separate therefrom. A separate processing can also be performed spatially separated from the production of the polyamide mixture, e.g. by a manufacturer of injection moulded parts. The polyamide composition A) and/or the polyamide composition B) used to provide the dry blend optionally contains at least one filler and reinforcing material and optionally contains at least one additive different from fillers and reinforcing materials. The preparation of the polyamide compositions A) and B) can be performed by feeding the polyamide in solid form to the intake of an extruder and melting the polyamide at a temperature above the melting temperature and optionally feeding at least one filler and reinforcing material and/or at least one additive different therefrom into the extruder and melt-blending the reaction mixture.

Preferably, the process for producing a polyamide molding composition according to the invention comprises melt-blending at least one polyamide A) and at least one polyamide B), optionally at least one filler and reinforcing material and optionally at least one additive different from fillers and reinforcing materials. By melt-blending, all of the polymeric components are well-dispersed within each other and all of the non-polymeric ingredients are well-dispersed in and bound by the polymer matrix, such that the blend forms a unified whole. For melt-blending, the polymeric components and non-polymeric ingredients may be added to a customary compounding machine, either all at once through a single step addition, or in a stepwise fashion, and then melt-blended. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

In a preferred embodiment, pellets of at least one polyamide A) and at least one polyamide B), optionally at least one filler and reinforcing material and optionally at least one additive different from fillers and reinforcing materials can be mixed to give a dry blend which is subsequently further processed. For example, in each case a compound in pellet form can first be prepared from the components A) and/or B), optionally the fillers ii) and/or additives iii), and these pellets can then be mixed to give a dry blend, optionally with addition of even further amounts of component A) and/or B) in pellet form. The dry blend prepared in this manner is then further processed. For further processing, the dry blend can be fed to a customary compounding machine.

In a further preferred embodiment, the polyamide molding composition according to the invention is prepared without previous production of a dry blend.

The preparation of the polyamide molding compositions according to the invention can be effected on customary compounding machines, preferably selected from a single or twin-screw extruder, a blender, a kneader, a Haake mixer, a Brabender mixer, a Banbury mixer or a roll mixer. Preferably, a single-screw or twin-screw extruders or a screw kneader is employed.

In one embodiment, the fraction of higher-melting polyamide A) is first melted, and the fraction of lower-melting polyamide B) is supplied temporally and/or spatially later. If the polyamide molding composition is prepared with an extruder, polyamide A) is fed at the beginning of the screw, and polyamide B) is fed via one or more than one side feed(s) downstream. If present, the at least one filler and reinforcing material ii) and additives iii) can be introduced partially or completely together with the polyamide A) at the beginning of the screw or via one or more than one side feed(s). Feeding the at least one filler and reinforcing material ii) and additives iii) via one or more than one side feed(s) can be effected partially or completely together with the polyamide B) or different therefrom.

The compounding is preferably effected at set barrel temperatures of at least 5° C., preferably at least 10° C., above the melting temperature Tₘ₁. The compounding is preferably effected at set barrel temperatures in the range from 300 to 360° C.

Preferably, an extruder is employed for producing a polyamide molding composition and the process comprises the following steps:
providing at least one polyamide A) and at least one polyamide B),
feeding the polyamide A) in solid form to the intake of the extruder and melting the polyamide A) at a temperature above the melting temperature Tₘ₁,
feeding the polyamide B) into the extruder via a side feed at a point downstream the intake, where the polymer A) is already in the molten state,
optionally feeding at least one filler and reinforcing material and/or at least one additive different therefrom into the extruder, where the filler and reinforcing materials and/or additives can be fed to the extruder in one or more portions via the intake and/or at a point downstream the intake.

The polymer extrudate produced from the polyamide molding composition according to the invention can be processed by all known pelletizing methods to give pellets, such as, for example, by pelletizing in which the extrudate is cooled in a water bath and then cut. Polymer extrudates having a higher fiber content, e.g. a fiber content of more than 60% by weight based on the total weight of the extrudate, can be subjected to underwater pelletizing or hot face cutting under water, in which the polymer melt is forced directly through a die and pelletized by a rotating knife in a water stream. The obtained pellets can be employed for preparing a molded article by known processes, in particular injection molding.

The polymer extrudate produced from the polyamide molding composition according to the invention can also be directly employed for preparing a molded article. In this case, the molten material leaving the extruder can be directly injected into a mold.

The polyamide mixture according to the invention and the polyamide molding composition comprising said polyamide mixture is suitable for all known injection molding processes, including multicomponent injection molding (2K, 3K) and hybrid technologies.

### Molded Articles

The polyamide mixture according to the invention and the polyamide molding composition comprising said polyamide mixture is advantageously suitable for use for production of moldings for various applications. The polyamide mixture and the polyamide molding composition according to the invention are suitable for manufacturing an article by shaping the polyamide composition by any shaping technique, such as for example extrusion, injection molding, thermoform molding, compression molding or blow molding.

The molded articles according to the invention are preferably selected from components for the automotive sector, electrical and electronic components and for metal replacement.

The polyamide mixture and the polyamide molding composition according to the invention are in particular suitable for under-the-hood applications, where resistance to heat, humidity and automotive fluids are important. A specific embodiment is that of moldings in the form of or as part of a component for the automotive sector, especially selected from cylinder head covers, engine hoods, housings for charge air coolers, charge air cooler valves, intake pipes, intake manifolds, connectors, gears, fan impellers, cooling water tanks, housings or housing parts for heat exchangers, coolant coolers, charge air coolers, thermostats, water pumps, fuel pumps, additive pumps (e.g. for AdBlue), water pump impellers, heating elements, securing parts.

Possible uses in automobile interiors are for dashboards, steering-column switches, seat components, headrests, center consoles, gearbox components and door modules, and possible uses in automobile exteriors are for door handles, exterior mirror components, windshield wiper components, windshield wiper protective housings, grilles, roof rails, sunroof frames, engine hoods, cylinder head covers, windshield wipers, and exterior bodywork parts.

A further specific embodiment is that of articles obtained by blow molding, e.g. selected from air ducts and pipes for transporting liquids and gases, inner linings for pipes, fuel lines, air break tubes, coolant pipes, pneumatic tubes, hydraulic houses, cable covers, cable ties, connectors, canisters, etc.

A further specific embodiment is a molded article in the form of a component or as part of a component for the sector of drinking water and industrial process water. In particular, the present invention provides a molded article for conveying and/or storage of water in particular at elevated temperatures, preferably in the region of and above 80° C. The molded article is then preferably selected from pipes, faucets, fittings, housings, mixers, taps, filter casings, water meters, water meter components (bearings, propellers, pins), valves, valve components (housing, shut-off ball, slide, cylinder), distributors, household devices (e.g. water heaters, rice cookers, steam cookers, steam irons), pumps, pump components (e.g. turbine wheels, impellors), containers, etc.

A further specific embodiment is that of moldings as or as part of an electrical or electronic passive or active component of a printed circuit board, of part of a printed circuit board, of a housing constituent, of a film, or of a wire, more particularly in the form of or as part of a switch, of a plug, of a bushing, of a distributor, of a relay, of a resistor, of a capacitor, of a winding or of a winding body, of a lamp, of a diode, of an LED, of a transistor, of a connector, of a regulator, of an integrated circuit (IC), of a processor, of a controller, of a memory element and/or of a sensor.

The polyamide mixture according to the invention and the polyamide molding composition comprising said polyamide mixture are additionally specifically suitable for use in soldering operations under lead-free conditions (lead free soldering), for production of plug connectors, microswitches, microbuttons and semiconductor components, especially reflector housings of light-emitting diodes (LEDs).

A specific embodiment is that of moldings as securing elements for electrical or electronic components, such as spacers, bolts, fillets, push-in guides, screws and nuts.

Especially preferred is a molding in the form of or as part of a socket, of a plug connector, of a plug or of a bushing. The molding preferably includes functional elements which require mechanical toughness. Examples of such functional elements are film hinges, snap-in hooks and spring tongues.

Possible uses of polyamides for the kitchen and household sector are for production of components for kitchen machines, for example fryers, smoothing irons, knobs, and also applications in the garden and leisure sector, for example components for irrigation systems or garden equipment and door handles.

A further object of the invention is the use of a polyamide mixture according to the invention or the polyamide molding composition comprising said polyamide mixture for production of a molded article with improved mechanical properties, in particular with improved weld line strength.

The examples which follow serve to illustrate the invention, but without restricting it in any way.

### EXAMPLES

The following abbreviations were used:

| | |
|---|---|
| HMD | 1,6-hexanediamine |
| 2-MOD | 2-methyl-1,8-octanediamine |
| T | terephthalic acid |
| I | isophthalic acid |
| 6T/6I | copolyamide of T, I and HMD (molar excess of T over I) |
| 6I/6T | copolyamide of T, I and HMD (molar excess of I over T) |
| 6T/66 | copolyamide of T, adipic acid and HMD |
| 9T | copolyamide of T and 1,9-nonanediamine (may also comprise |
| | a mixture of 1,9-nonanediamine and 2-methyloctamethylene |
| | diamine to adjust the melting temperature of the PA 9T |
| | to the desired value) |

### Analytical Methods

### I) Molecular Weight Determination by Means of GPC:

Standard: PMMA
Eluent: hexafluoroisopropanol+0.05% potassium trifluoroacetate
Flow rate: 1 ml/min
Column pressure: precolumn 7.5 MPa, separation columns 75 MPa
Column set: 1 precolumn (I=5 cm), 2 separation columns (I=30 cm each)
Detector: DRI (refractive index detector) Agilent 1100

### II) Melting Temperatures:

The melting temperatures Tₘ in tables 1 and 2 were determined by means of dynamic differential calorimetry (DSC) by the method according to DIN EN ISO 11357-3. The DSC analysis was repeated once each time, and the sample was kept at melting temperature for 5 minutes, in order to ensure a defined thermal history of the polyamide. Measurement was effected in each case under nitrogen in open aluminum crucibles at a heating rate and cooling rate of 20 K/min.

### III) Determination of the Weld Line Strength

The specimens for the measuring of the weld line strength are molded according to ISO 294-1 in a mold according to ISO 294-1 annex, Figure A.1 Type C: “Variant with double T-runner”. In such a mold, the polymer melt is divided into two flow fronts meeting again in the middle of the parallel measuring area forming the weld line. The measuring of the weld line strength is performed according to ISO 527-2.

### Preparation of the Polyamides

### Polyamides A)

The following compositions comprise a high-melting polyamide as polyamide component A).

### Example 1 (Polyamide Composition A.I) PA 6T/6I

As polyamide composition A.I a PA 6T/6I composition reinforced with glass fibres, stabilised with 0.6 wt.-% of 4,4′-Bis(alpha, alpha-dimethylbenzyl)diphenylamine (Naugard 445) as heat stabiliser, colorized with 0.2 wt.-% of carbon black and comprising 40 wt.-% glass fibres having a diameter of 10 μm was employed.

The PA 6T/6I has a molar ratio of T/I=70/30, a number-average molecular weight Mn of 13300 g/mol and a PD of 3.3. The synthesis is described in detail in WO 2014/198764 A1, comparative example V3.

### Example 2 (Polyamide Composition A.II) PA 6T/6I

The employed polyamide was PA 6T/6I, as described in WO 2014/198764 A1, comparative example V3 with a molar ratio of T/I=70/30, number-average molecular weight Mₙ of 13300 g/mol and a melting temperature Tₘ of 318° C.

For the preparation of the polyamide composition, the polyamide was fed together with 0.6 wt.-% of 4,4′-Bis(alpha, alpha-dimethylbenzyl)diphenylamine (Naugard 445), 0.5 wt.-% of a release agent (Luwax® OA5 from BASF SE) and 0.2 wt.-% of a nucleating agent (Talkum IT Extra) to the feeder of a twin screw extruder. The employed extruder was a counter rotating twin screw extruder with 12 barrel segments and side feeders at barrel segments 5 and 8. Chopped glass fibres (DS1110-10N available from 3B Fibreglass, having a diameter of 10 μm and a length of 5 mm) were added via the side feed at barrel segment 5 to the molten mass.

### Polyamides B)

The following low-melting polyamides were used as polyamide component B).

### Example 3 (Polyamide B.I) 6I/6T

Amorphous PA 6I/6T (Selar® PA3426 by DuPont Comp.) having an inherent viscosity of 0.82 determined by ASTM D4066 and a glass transition temperature of 125° C. measured by DSC.

### Example 4 (Polyamide B.II) 6T/66

PA 6T/66 (Grivory® HT2-3H by Ems Chemicals, Inc.) having a melting temperature Tₘ of 310° C.

### Example 5 (Polyamide B.III) Compound From a Polyamide 9T Blend

Equal amounts of the following two polyamides were subjected to a melt blending:
1) PA 9T (Genestar® N1000A by Kuraray Co. Ltd.) having a Tₘ of 300° C.
2) PA 9T (Genestar® N1001D by Kuraray Co. Ltd.) having a Tₘ of 264° C.

The resulting composition has a melting temperature Tₘ of 280° C.

### Example 6 (Polyamide B.IV) 9T

PA 9T (Genestar® N1001D by Kuraray Co. Ltd.) having a Tₘ of 264° C.

### Experimental Series 1 (Mixtures of Polyamide Pellets)

The specimens were prepared with an injection molding machine (Arburg Allrounder) with cylinder temperatures of 250° C. to 350° C. and a screw speed of 15 m/min. The molding temperature was 120°° C. to 160° C. Specimens for the determination of the weld line strength were made by blending of the pellets from A.I and B.I to B.III as described above. The specimens were produced with tensile rods injection-molded on both sides.

TABLE 1

| | | | | | Tₘ weld |
|---|---|---|---|---|---|
| | | | | | line |
| | | | | weld line | tensile |
| Ex. | | Tₘ₁ | Tₘ₂ | strength | bar |
| No. | polyamide mixture | [° C.] | [° C.] | [MPa] | [° C.] |
| C1*⁾ | polyamide (A.I) 6T/6I | 321 | — | 65 | 321 |
| | 40 wt. % glass fibers | | | | |
| C2*⁾ | polyamide (A.I) 6T/6I/ | 321 | — | 72 | 315 |
| | polyamide (B.I) 6I/6T | | (amorphous) | | |
| | 95/5 wt.-% | | | | |
| | 38 wt. % glass fibers | | | | |
| C3*⁾ | polyamide (A.I) 6T/6I/ | 321 | — | 61 | 312 |
| | polyamide (B.I) 6I/6T | | (amorphous) | | |
| | 90/10 wt.-% | | | | |
| | 36 wt. % glass fibers | | | | |
| 1 | polyamide (A.I) 6T/6I/ | 321 | 302 | 77 | 319 |
| | polyamide (B.I) 6T/66 | | | | |
| | 90/5 wt.-% | | | | |
| | 39.5 wt. % glass fibers | | | | |
| 2 | polyamide (A.I) 6T/6I/ | 321 | 302 | 80 | 318 |
| | polyamide (B.I) 6T/66 | | | | |
| | 90/10 wt.-% | | | | |
| | 39 wt. % glass fibers | | | | |
| 3 | polyamide (A.I) 6T/6I/ | 321 | 280 | 84 | 316 |
| | polyamide (B.II) 9T | | | | |
| | 95/5 wt.-% | | | | |
| | 38 wt. % glass fibers | | | | |
| 4 | polyamide (A.I) 6T/6I | 321 | 280 | 105 | 312 |
| | polyamide (B.III) 9T | | | | |
| | 90/10 wt.-% | | | | |
| | 36 wt. % glass fibers | | | | |

*⁾comparative example

### Experimental Series 2: (Polyamide Compounds)

The preparation of the polyamide compounds was performed analogous to the preparation of polyamide composition A.II in example 2. Polyamides B.II, B.III were added to barrel segments 5 and 8, respectively. The quantity of A.II was reduced by the quantity of B.III or B.IV. In each case, the amount of glass fibers was adjusted to 40%.

The polyamide compounds were used to produce specimens for the determination of the weld line strength according to the method described above. The results are shown in table 2.

TABLE 2

| | | | | weld |
|---|---|---|---|---|
| | | | | line |
| Ex. | | Tₘ₁ | Tₘ₂ | strength |
| No. | polyamide mixture | [° C.] | [° C.] | [MPa] |
| C4*⁾ | polyamide (A.II) 6T/6I | 321 | — | 67 |
| | 40 wt. % glass fibers | | | |
| 5 | polyamide (A.II) 6T/6I/ | 321 | 280 | 80 |
| | polyamide (B.III) 9T | | | |
| | 96/4 wt.-% | | | |
| | 40 wt. % glass fibers | | | |
| 6 | polyamide (A.II) 6T/6I polyamide | 321 | 280 | 87 |
| | (B.III) 9T | | | |
| | 92/8 wt.-% | | | |
| | 40 wt. % glass fibers | | | |
| 7 | polyamide (A.II) 6T/6I polyamide | 321 | 280 | 95 |
| | (B.III) 9T | | | |
| | 88/12 wt.-% | | | |
| | 40 wt. % glass fibers | | | |
| 8 | polyamide (A.II) 6T/6I polyamide | 321 | 260 | 82 |
| | (B.IV) 9T | | | |
| | 96/4 wt.-% | | | |
| | 40 wt. % glass fibers | | | |
| 9 | polyamide (A.II) 6T/6I/ | 321 | 260 | 81 |
| | polyamide (B.IV) 9T | | | |
| | 92/8 wt.-% | | | |
| | 40 wt. % glass fibers | | | |
| 10 | polyamide (A.II) 6T/6I/ | 321 | 260 | 95 |
| | polyamide (B.IV) 9T | | | |
| | 88/12 wt.-% | | | |
| | 40 wt. % glass fibers | | | |
| 11**⁾ | polyamide (A.II) 6T/6I/ | 321 | 260 | 96 |
| | polyamide (B.IV) 9T | | | |
| | 96/4 wt.-% | | | |
| | 40 wt. % glass fibers | | | |

*⁾comparative example
*⁾corresponds to example 8 with the difference that polyamide B.IV was feed to the extruder more downstream (compounding zone at barrel segment 8 instead of 5)

1. A polyamide mixture comprising:
80 to 97% by weight of at least one polyamide A), containing repeat units derived from at least one aromatic dicarboxylic acid and at least one aliphatic diamine, wherein the at least one aromatic dicarboxylic acid comprises or consists of terephthalic acid, having a melting temperature Tₘ₁, and
3 to 20% by weight of at least one polyamide B), containing repeat units derived from at least one aromatic dicarboxylic acid and at least one aliphatic diamine, wherein the at least one aromatic dicarboxylic acid comprises or consists of terephthalic acid, having a melting temperature Tₘ₂,
wherein Tₘ₁ is at least 10° C. higher than Tₘ₂.

2. The polyamide mixture according to claim 1, wherein Tₘ₁ is at least 15° C. higher than Tₘ₂.

3. The polyamide mixture according to claim 1, wherein the at least one polyamide A) has a melting temperature Tₘ₁ in the range from 290 to 340° C.

4. The polyamide mixture according to claim 1, wherein the at least one polyamide B) has a melting temperature Tₘ₂ in the range from 250 to 315° C.

5. The polyamide mixture according to claim 1, wherein the at least one polyamide A) and the at least one polyamide B) contain repeat units, derived from at least one aliphatic diamine, independently selected from the group consisting of tetramethylene diamine, pentamethylene diamine, hexamethylene diamine, heptamethylene diamine, octamethylene diamine, nonamethylene diamine, decamethylene diamine, undecamethylene diamine, dodecamethylene diamine, 2-ethyltetramethylene diamine, 2-methylpentamethylene diamine, 2,2,4-trimethylhexamethylenediamine, 2,4,4-trimethylhexamethylenediamine, 2-methyloctamethylene diamine, 2,4-dimethyloctamethylenediamine, 5-methylnonamethylene diamine and mixtures thereof.

6. The polyamide mixture according to claim 1, wherein the at least one polyamide A) is selected from the group consisting of PA 6T/6I, PA 6T/DT, PA 4T, and mixtures thereof.

7. The polyamide mixture according to claim 1, wherein the at least one polyamide B) is selected from the group consisting of PA 8T, PA 9T, PA 10T, PA 6T/66 and mixtures thereof.

8. A polyamide molding composition comprising
i) 25 to 100% by weight of at least one polyamide mixture as defined in claim 1,
ii) 0 to 75% by weight of at least one filler and reinforcing material,
iii) 0 to 50% by weight of at least one additive,
wherein components i) to iii) together add up to 100% by weight.

9. A process for producing a polyamide molding composition, comprising mixing a polyamide composition comprising at least one polyamide A) and a polyamide composition comprising at least one polyamide B), as defined in claim 1, to give a dry blend, wherein the polyamide compositions optionally contain at least one filler and reinforcing material and optionally at least one additive different from fillers and reinforcing materials.

10. A process for producing a polyamide molding composition, comprising melt-blending at least one polyamide A) and at least one polyamide B), as defined in claim 1, optionally at least one filler and reinforcing material and optionally at least one additive different from fillers and reinforcing materials.

11. The process according to claim 10, wherein an extruder is employed and the process comprises the following steps:
providing at least one polyamide A) and at least one polyamide B), as defined in claim 1,
feeding the polyamide A) in solid form to the intake of the extruder and melting the polyamide A) at a temperature above the melting temperature Tₘ₁,
feeding the polyamide B) into the extruder via a side feed at a point downstream the intake where the polymer A) is already in the molten state,
optionally feeding at least one filler and reinforcing material and/or at least one additive different therefrom into the extruder, wherein the filler and reinforcing materials and/or additives can be fed to the extruder in one or more portions via the intake and/or at a point downstream the intake.

12. A molded article produced from a polyamide molding composition according to claim 8.

13. The molded article according to claim 12,
in the form of a component or as part of a component for the automotive sector,
in the form of a component or as part of a component for the heating sector,
in the form of a component or as part of a component for the sector of drinking water and industrial process water,
in the form of an electrical or electronic component or as a part thereof, or
in the form of a component for the kitchen and household sector or as a part thereof.

14. A process for producing a molded article by subjecting a polyamide molding composition according to claim 8 to an injection molding or blow molding.

15. A method of using the polyamide mixture as defined in claim 1 for production of a molded article with improved mechanical properties.

16. The polyamide mixture according to claim 1, wherein the at least one polyamide B) has a melting temperature Tm2 in the range from 260 to 280° C.

17. A molded article prepared by a process according to claim 9.

18. A process for producing a molded article by subjecting a polyamide molding composition prepared by a process according to claim 9 to an injection molding or blow molding.

19. A method of using the molding composition as defined in claim 8 for production of a molded article with improved mechanical properties.

20. The method of claim 15, wherein the method produces a molded article with improved weld line strength.
